(19) United States
(12) Patent Application Publication
(10) Pub. No.: US 2025/0066168 A1
(43) Pub. Date: Feb. 27, 2025

(54) ROPE INSPECTION DEVICE AND WORK MACHINE INCLUDING SAME

(71) Applicant: KOBELCO CONSTRUCTION MACHINERY CO., LTD., Hiroshima-shi (JP)

(72) Inventors: Teppei MAEDO, Hyogo (JP); Hiroki NAKAYAMA, Hyogo (JP); Yohei OGAWA, Hyogo (JP); Takao ETO, Hyogo (JP); Kazufumi KUDARA, Hyogo (JP)

(73) Assignee: KOBELCO CONSTRUCTION MACHINERY CO., LTD., Hiroshima-shi (JP)

(21) Appl. No.: 18/723,934

(22) PCT Filed: Oct. 28, 2022
(86) PCT No.: PCT/JP2022/040312

§ 371 Date: Jun. 25, 2024

(30) Foreign Application Priority Data
Dec. 27, 2021 (JP) 2021-212415

(51) Int. Cl. B66D 1/54; B66C 13/00; B66C 23/36; B66C 23/88

(52) U.S. Cl. CPC B66D 1/54; B66C 13/00; B66C 23/36; B66C 23/88

(57) ABSTRACT

A rope inspection device according to the present invention is attached to a work machine that has a machine body, a rising/lowering body capable of rising/lowering relative to the machine body, a winch, and a rope which is led out from the winch and suspended from a tip end of the rising/lowering body and which is connected to a load to be suspended. The rope inspection device includes: a rope inspection instrument capable of inspecting a deterioration state of the rope; and a support unit which is attached to the tip end of the rising/lowering body and which supports the rope inspection instrument such that the rope inspection instrument can follow movement in the horizontal direction of the rope which is suspended from the tip end.

### TECHNICAL FIELD

The present invention relates to a rope inspection device and a work machine including the same.

### BACKGROUND ART

A crane that can hoist a load to be suspended is conventionally known as a work machine. The crane includes a machine body, a rising/lowering body capable of rising/lowering relative to the machine body, a suspended load rope suspended from a tip end of the rising/lowering body and connected to a load to be suspended, and a suspended load winch for winding and unwinding the suspended load rope. The crane further includes a rising/lowering rope and a rising/lowering winch. The rising/lowering rope is connected to a tip end of the rising/lowering body via a guy link or the like, and when the rising/lowering winch winds and unwinds the rising/lowering rope, the rising/lowering body rises/lowers relative to the machine body. In such a crane, the rope may be deteriorated or damaged with long-term work.

Patent Literature 1 discloses a technique in which the rising/lowering rope is coated with paint, and the color and peeling of the paint are photographed by a camera fixed to the top of a gantry to determine the life of the rope.

### CITATION LIST

### Patent Literature

Patent Literature 1: JP H7-117989 A

In the technique described in Patent Literature 1, since the camera as a rope inspection device is fixed to the top of the gantry, it is not possible to accurately inspect deterioration of the suspended load rope suspended from the tip end of the rising/lowering body. In the technique, the distance between the camera and the rope varies in response to work of the crane, particularly rising/lowering of a boom, and therefore, the technique has a problem of difficulty in accurately detecting deterioration of the rope.

### SUMMARY OF INVENTION

An object of the present invention is to provide a rope inspection device that can accurately detect deterioration of a suspended load rope used in a work machine, and a work machine including the same.

Provided by the present invention is a rope inspection device attached to a work machine that has a machine body, a rising/lowering body capable of rising/lowering relative to the machine body, a winch, and a rope which is led out from the winch and suspended from a tip end of the rising/lowering body and which is connected to a load to be suspended. The rope inspection device includes: a rope inspection instrument capable of inspecting a deterioration state of the rope; and a support unit which is attached to the tip end of the rising/lowering body and which supports the rope inspection instrument such that the rope inspection instrument can follow movement in a horizontal direction of the rope which is suspended from the tip end.

Also provided by the present invention is a work machine. The work machine includes a machine body, a rising/lowering body capable of rising/lowering relative to the machine body, a winch, a rope which is led out from the winch and suspended from a tip end of the rising/lowering body and which is connected to a load to be suspended, and the rope inspection device described above attached to the tip end of the rising/lowering body.

### BRIEF DESCRIPTION OF DRAWINGS

FIG. 1 is a side view of a crane according to a first embodiment of the present invention.

FIG. 2 is a side view of a rope inspection device of the crane according to the first embodiment of the present invention.

FIG. 3 is a front view of the rope inspection device of the crane according to the first embodiment of the present invention.

FIG. 4 is a plan view of the rope inspection device of the crane according to the first embodiment of the present invention.

FIG. 5 is a front view of a rope inspection device of a crane according to a second embodiment of the present invention.

FIG. 6 is a side view of a rope inspection device of a crane according to a third embodiment of the present invention.

FIG. 7 is a front view of the rope inspection device of the crane according to the third embodiment of the present invention.

FIG. 8 is a perspective view of the rope inspection device of the crane according to the third embodiment of the present invention.

FIG. 9 is a front view of a rope inspection device of a crane according to a fourth embodiment of the present invention.

FIG. 10 is an assembly process diagram of the rope inspection device of the crane according to the fourth embodiment of the present invention.

FIG. 11 is a side view of a rope inspection device of a crane according to a fifth embodiment of the present invention.

FIG. 12 is a front view of the rope inspection device of the crane according to the fifth embodiment of the present invention.

FIG. 13 is a plan view of the rope inspection device of the crane according to the fifth embodiment of the present invention.

### DESCRIPTION OF EMBODIMENTS

### First Embodiment

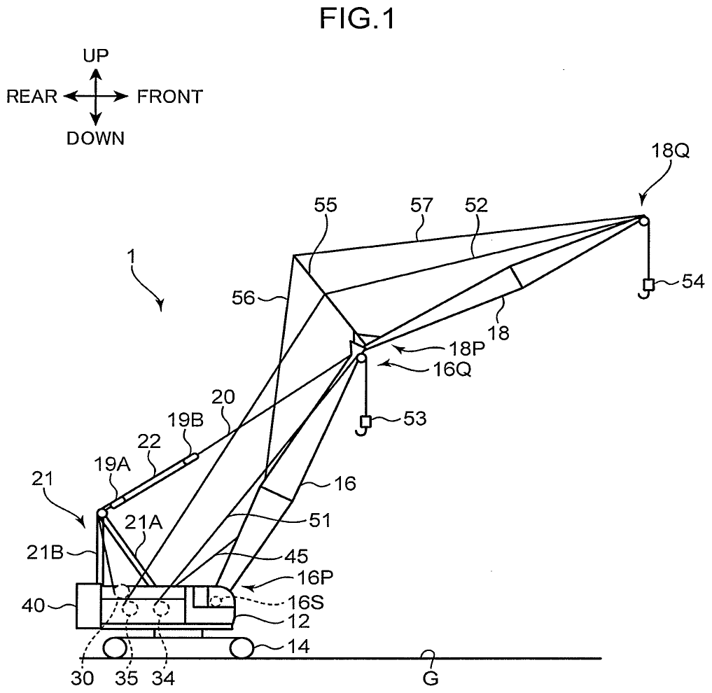

Embodiments of the present invention will be described below with reference to the drawings. FIG. 1 is a side view of a crane 1 (work machine) according to the first embodiment of the present invention. Note that hereinafter, each drawing indicates directions of “up”, “down”, “left”, “right”, “front”, and “rear”, but the directions are indicated for convenience of describing the structure of the crane 1 according to each embodiment, and do not limit a moving direction, a use mode, and the like of the crane according to the present invention.

The crane 1 includes an upper slewing body 12, a lower travelling body 14, a boom 16, a jib 18, a lower spreader 19A, an upper spreader 19B, a pair of left and right boom guy lines 20, a gantry 21, a boom raising/lowering rope 22, a boom raising/lowering winch 30, a main winding winch 34, an auxiliary winding winch 35, a counterweight 40, and a pair of left and right backstops 45. The crane 1 further includes ropes 51 and 52, a main hook 53, an auxiliary hook 54, a strut 55, a pair of left and right strut guy lines 56, and a pair of left and right jib guy lines 57. Note that in the following description, the pair of left and right members have the left and right structures that are same, and therefore one of the left and right structures will be described.

The upper slewing body 12 constitutes a crane body (machine body) of the crane 1, and is supported by the lower travelling body 14 so as to be slewable about a slewing center axis extending in an up-down direction. The lower travelling body 14 can travel on a travelling surface such as a ground G.

The boom 16 is supported by the upper slewing body 12 to be capable of rising/lowering. Specifically, the boom 16 includes a boom base end 16P and a boom tip end 16Q. The boom base end 16P is supported turnably in a rising/lowering direction about a boom rotation center axis horizontal to the upper slewing body 12. The boom tip end 16Q is disposed on the side opposite to the boom base end 16P in a longitudinal direction. In the present embodiment, a boom foot 16S included in the boom base end 16P is turnably supported by a shaft support part not illustrated of the upper slewing body 12. As an example, the boom 16 is a so-called lattice type, and is configured by coupling a plurality of boom members to each other. The structure of the boom 16 is not limited to this, and may be a box-like structure or a telescopic structure. The position for supporting the boom 16 is not limited to the front side of the upper slewing body 12, and may be the rear side. A pair of left and right backstops 45 are supported on the back surface of the boom 16. These backstops 45 each abut against the upper slewing body 12 in a standing posture of the boom 16 (work posture of the crane 1). This abutment restricts the boom 16 from being blown backward by strong wind or the like.

The jib 18 is supported turnably in a rising/lowering direction about a turn center axis horizontal to the boom tip end 16Q of the boom 16. The jib 18 includes a jib base end 18P and a jib tip end 18Q. Note that the jib 18 constitutes the rising/lowering body of the present invention together with the boom 16. The rising/lowering body can rise/lower relative to the upper slowing body 12.

The lower spreader 19A is connected to the tip end of the gantry 21 and has a lower sheave block not illustrated. In the lower sheave block, a plurality of sheaves are arrayed in the width direction (left-right direction).

The upper spreader 19B is disposed at a predetermined interval in front of the lower spreader 19A. The upper spreader 19B is connected to the boom tip end 16Q via the boom guy line 20. The upper spreader 19B includes an upper sheave block not illustrated. In the upper sheave block, a plurality of sheaves are arrayed in the width direction (left-right direction).

The pair of left and right boom guy lines 20 are disposed at intervals to each other in the left-right direction orthogonal to the paper surface of FIG. 1. A rear end of each of the boom guy lines 20 is connected to the upper spreader 19B, and a front end of each of the boom guy lines 20 is removably connected to the boom tip end 16Q. The boom guy line 20 may have any structure such as a guy link (metal plate material), a guy rope, or a guy wire (metal wire material).

The gantry 21 is supported by the upper slewing body 12 at the rear of the boom 16. As illustrated in FIG. 1, the gantry 21 is configured by two structures (a compression member 21A and a tension member 21B) forming a substantially triangular shape between the gantry 21 and the upper slewing body 12. The tension member 21B extends substantially vertically upward from the rear end of the upper slewing body 12. The compression member 21A connects the upper end of the tension member 21B and a substantially center part of the upper slewing body 12 along an oblique direction. The gantry 21 supports the boom 16 from the rear such that the boom 16 is capable of rising/lowering.

The boom raising/lowering rope 22 is led out from the boom raising/lowering winch 30, hung on the sheave disposed at the tip end of the tension member 21B, and then wound a plurality of times between the lower sheave block of the lower spreader 19A and the upper sheave block of the upper spreader 19B. Note that the tip end of the boom raising/lowering rope 22 after being wound around the lower sheave block and the upper sheave block is fixed to the tip end (upper end) of the gantry 21.

The boom raising/lowering winch 30 is disposed on the upper slewing body 12. By winding and unwinding the boom raising/lowering rope 22, the boom raising/lowering winch 30 changes the distance between the lower sheave block of the lower spreader 19A and the upper sheave block of the upper spreader 19B, and raises/lowers the boom 16 while turning the boom 16 relative to the gantry 21.

The main winding winch 34 (winch) winds up and winds down a load to be suspended by the rope 51 (suspended load rope). Regarding this main winding, the boom tip end 16Q of the boom 16 is provided with a main winding point sheave. The main hook 53 connected to the load to be suspended is coupled to the rope 51 led out from the main winding winch 34 and suspended from the main winding point sheave. Therefore, when the main winding winch 34 winds up or winds out the rope 51, the main hook 53 is wound up or wound down.

Similarly, the auxiliary winding winch 35 (winch) winds up and winds down the load to be suspended by the rope 52 (suspended load rope). Regarding this auxiliary winding, the tip end of the jib 18 is provided with an auxiliary winding point sheave. The auxiliary hook 54 connected to the load to be suspended is coupled to the rope 52 led out from the auxiliary winding winch 35 and suspended from an auxiliary winding point. Then, when the auxiliary winding winch 35 winds up or winds out the rope 52, the auxiliary hook 54 for the load to be suspended coupled to the terminal of the rope 52 is wound up or wound down.

The counterweight 40 is loaded on the rear of the upper slewing body 12 in order to adjust the balance of the crane 1.

The strut 55 is supported turnably in the rising/lowering direction to the jib base end 18P of the jib 18. The strut 55 functions as a pillar supporting the jib 18 from the rear. The tip end of the strut 55 is connected to a longitudinal center of the boom 16 by a strut guy line 56 and is connected to the jib tip end 18Q of the jib 18 by the jib guy line 57.

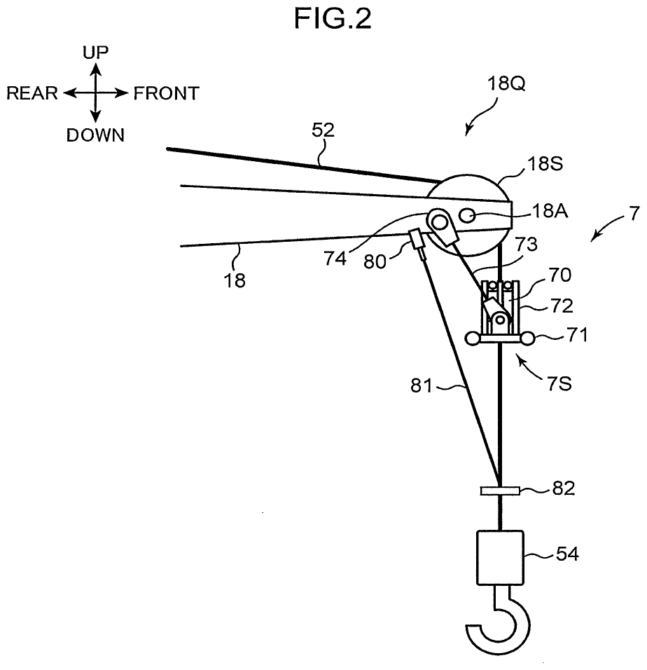

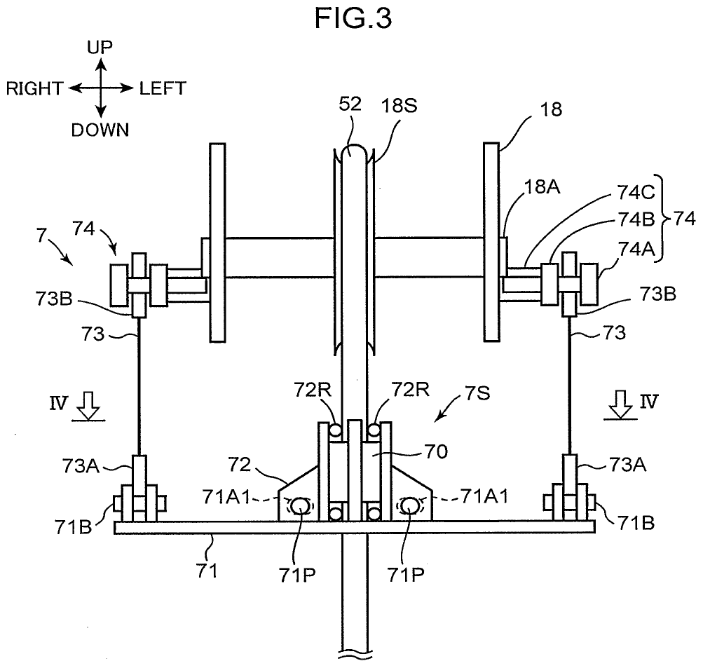

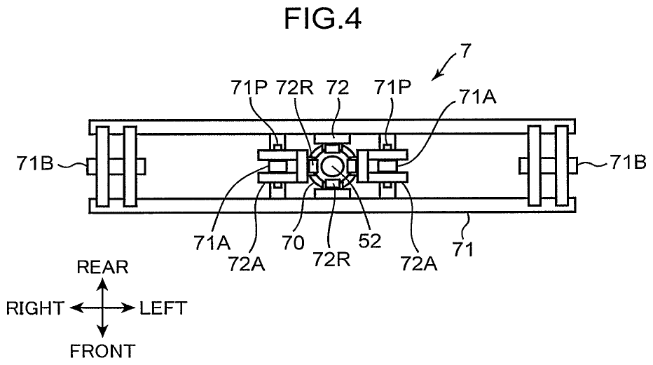

FIGS. 2, 3, and 4 are a side view, a front view, and a plan view of a rope inspection device 7 of the crane 1 according to the present embodiment. FIG. 4 corresponds to a view viewed along an arrow IV-IV of FIG. 3. Note that in FIGS. 2 to 4, in order to facilitate the explanation, each direction is indicated in a state where the jib 18 in FIG. 1 is lowered so as to extend horizontally.

The jib 18 includes a point sheave 18S and a sheave rotation shaft 18A. The point sheave 18S includes an outer peripheral surface that is disposed at the jib tip end 18Q and supports the rope 52. The sheave rotation shaft 18A rotatably supports the point sheave 18S. As illustrated in FIG. 3, the sheave rotation shaft 18A is supported by a pair of left and right frame parts of the jib 18. The point sheave 18S is supported at the center part of left and right of the sheave rotation shaft 18A.

The crane 1 further includes the rope inspection device 7. In the present embodiment, the rope inspection device 7 is provided at the tip end of the jib 18, and inspects a deterioration and damage degree of the rope 52. The rope inspection device 7 is removable with respect to the jib tip end 18Q of the jib 18. The rope inspection device 7 includes a rope deterioration detection instrument 70 (rope inspection instrument) and a support unit 7S (FIG. 2).

The rope deterioration detection instrument 70 can inspect a deterioration state of the rope 52. In the present embodiment, the rope deterioration detection instrument 70 has a cylindrical shape (tubular shape), and receives the rope 52 in an internal space of the cylindrical shape along the up-down direction. The rope deterioration detection instrument 70 generates a magnetic field in the internal space, and detects deterioration of the rope 52 by a change in the magnetic field. At this time, since the rope deterioration detection instrument 70 has a tubular shape, the state of the entire circumference of the rope 52 can be measured. A cylindrical inner peripheral surface of the rope deterioration detection instrument 70 may be attached with a resin member or the like for enhancing the slidability of the rope 52. Note that the mechanism by which the rope deterioration detection instrument 70 detects deterioration of the rope 52 is not limited to the above magnetic one, and may be a mechanical one or an optical one. The rope deterioration detection instrument 70 is not limited to a cylindrical shape, and may have another tubular shape, or a plate shape, a cuboid shape, or the like dispose to face the rope 52.

The support unit 78 is attached to the jib tip end 18Q of the jib 18. The support unit 7S supports the rope deterioration detection instrument 70 such that the rope deterioration detection instrument 70 can follow movement in the horizontal direction of the rope 52 suspended from the jib tip end 18Q. The support unit 7S includes a support frame 71, a support body 72, a pair of left and right support cables 73, and a pair of left and right cable fixing parts 74.

As illustrated in FIGS. 3 and 4, the support frame 71 is a member extending long in the left-right direction, and is configured by joining a plurality of steel materials extending long in the front-rear direction or the left-right direction. The support frame 71 includes a pair of left and right frame connection parts 71A (FIG. 4) and a pair of left and right frame supported parts 71B. Each of the frame connection parts 71A is a part connected to the support body 72 of the support frame 71. A long hole 71A1 (FIG. 3) extending in the left-right direction is formed in each of the frame connection parts 71A. Each of the frame supported parts 71B is supported by the support cable 73 by being connected to a tip end connection part 73A of the support cable 73. Note that the tip end connection part 73A of the support cable 73 is swingably connected to the frame supported part 71B.

The support body 72 is fixed to the support frame 71 and supports the rope deterioration detection instrument 70. In the present embodiment, the support body 72 supports the rope deterioration detection instrument 70 having a tubular shape so as to surround the rope deterioration detection instrument along a horizontal plane. In other words, the support body 72 (FIG. 4) supports the rope deterioration detection instrument so as to sandwich the rope deterioration detection instrument 70 from front and rear as well as left and right. The support body 72 includes a pair of left and right support walls 72A each having a U shape in plan view in FIG. 4. Each of the support walls 72A is provided with a pin hole facing the long hole 71A1. Therefore, on the both left and right sides, in a state where each of the support walls 72A receives the frame connection part 71A of the support frame 71, a connection pin 71P is inserted into the long hole 71A1 of the frame connection part 71A and the pin hole of the support wall 72A, thereby connecting the support frame 71 and the support body 72.

The support body 72 includes eight guide rollers 72R. As illustrated in FIGS. 3 and 4, four guide rollers 72R are rotatably supported each of above and below the rope deterioration detection instrument 70 in the support body 72. These rollers have a function of guiding the rope 52 such that the rope 52 passes through the cylindrical center part of the rope deterioration detection instrument 70.

Note that the support body 72 constitutes a support mechanism of the present invention together with the above-described support frame 71. The support mechanism is connected to the tip ends of the pair of support cables 73 and supports the rope deterioration detection instrument 70.

The pair of left and right support cables 73 are each suspended from the jib tip end 18Q of the jib 18. The tip end connection part 73A is disposed at the tip end of the support cable 73 (FIG. 3), and a base end connection part 73B is disposed at the base end of the support cable 73.

The cable fixing part 74 is fixed to each of the left and right frames of the jib 18 (FIG. 3) on the rear side of the sheave rotation shaft 18A (FIG. 2). The cable fixing part 74 includes a fixing bolt 74A, a nut 74B, and a fixing protrusion 74C. The fixing protrusion 74C is a columnar member fixed to the frame of the jib 18. A bolt hole is formed in the fixing protrusion 74C. As illustrated in FIG. 3, the fixing bolt 74A is fastened to the bolt hole in a state where the base end connection part 73B of the support cable 73 and the nut 74B are sandwiched between the fixing bolt 74A and the fixing protrusion 74C, whereby the pair of left and right support cables 73 are supported by the jib tip end 18Q. At this time, the base end connection part 73B is supported swingably in the front-rear direction about the fixing bolt 74A.

Furthermore, the jib tip end 18Q of the jib 18 includes an overwound limit switch 80, an overwound limit cable 81 (detection cable), and a cable connection plate 82.

The overwound limit switch 80 is attached to the jib tip end 18Q of the jib 18. In the present embodiment, the overwound limit switch 80 is attached to an immediately rear side part of the cable fixing part 74 on the right side. The overwound limit cable 81 is a cable led out from the overwound limit switch 80. The cable connection plate 82 is a plate member attached to a tip end of the overwound limit cable 81, and a hole part for receiving the rope 52 is opened in a center thereof. Note that the cable connection member exemplified by the cable connection plate 82 is not limited to a plate shape, and may have another form such as a ring shape, a cylindrical shape, a rectangular shape, and a shape in which two rings of upper and lower are coupled by a rod-shaped coupling member.

When in the state illustrated in FIG. 2, the auxiliary winding winch 35 (FIG. 1) continues winding up the rope 52 in response to the operation of a worker, the auxiliary hook 54 eventually pushes up the cable connection plate 82. As a result, the tension of the overwound limit cable 81 is weakened, and the overwound limit switch 80 detects the change. The overwound limit switch 80 detects an overwound state of the rope 52 and inputs a signal corresponding to the detection result to a control unit not illustrated of the crane 1. As a result, the worker can grasp the overwound state of the rope 52.

As described above, according to the present embodiment, the support unit 8S supports the rope deterioration detection instrument 70 such that the rope deterioration detection instrument 70 can inspect the rope 52 suspended from the tip end of the jib 18. In particular, the support unit 7S supports the rope deterioration detection instrument 70 such that the rope deterioration detection instrument 70 can follow movement in the horizontal direction of the rope 52. Therefore, even when the jib 18 rises/lowers relative to the boom 16 and the upper slewing body 12 or even when the rope 52 swings with the jib tip end 18Q of the jib 18 as a fulcrum, the rope deterioration detection instrument 70 can move following the rope 52, and thus the rope 52 can be stably inspected.

In particular, in the present embodiment, since the support mechanism that supports the rope deterioration detection instrument 70 is supported by the pair of support cables 73, the rope deterioration detection instrument 70 can swing with the jib tip end 18Q of the jib 18 as a fulcrum so as to follow movement of the rope 52.

At this time, since the base end connection parts 73B of the pair of support cables 73 are supported by the cable fixing part 74 including the fixing bolt 74A, it is not necessary to weld the support cable 73 to the jib tip end 18Q of the jib 18, and the rope inspection device 7 can be easily attached. Therefore, the rope inspection device 7 can be attached afterward also to the crane 1 that does not have the conventional rope inspection device 7.

The support mechanism includes the support frame 71 connected to the tip ends of the pair of support cables 73, and the support body 72 fixed to the center of the support frame 71 and supporting the rope deterioration detection instrument 70. According to such a configuration, in a state where the support frame 71 is supported by the pair of support cables 73, the support body 72 can stably support the rope deterioration detection instrument 70 at the center of the support frame 71. As a result, the support mechanism is prevented from tilting due to the weight of the rope deterioration detection instrument 70.

Furthermore, in the present embodiment, since the rope deterioration detection instrument 70 has a tubular shape that receives the rope 52, the rope deterioration detection instrument 70) and the rope 52 do not greatly separate from each other, and the deterioration state of the rope 52 can be stably inspected.

In the present embodiment, since the connection pin 71P connecting the support frame 71 and the support body 72 is inserted into the long hole 71A1, the support body 72 can relatively move left and right by the stroke of the long hole 71A1 with respect to the support frame 71 when the rope 52 swings to the left and right. Therefore, the rope deterioration detection instrument 70 sandwiched between the rope 52 and the support body 72 is suppressed from being applied with a large load.

Note that inspection of the rope 52 by the rope inspection device 7 may be performed during work of the crane 1, or may be performed after end or before start of the work. In the present embodiment, since it is possible to constantly monitor the rope 52, it is possible to prevent damage of the rope 52 due to overlooking from becoming severe as compared with a case of visual inspection and confirmation by the worker.

Furthermore, it is desirable that the rope inspection device 7 be removable with respect to the jib 18. In this case, since the rope inspection device 7 can be removed from the jib 18 during disassembly and transportation of the crane 1, the members constituting the jib 18 can be transported within the transport restriction height of the transport vehicle. In a case where an immediate inspection is unnecessary such as a case where the rope 52 that is unused is prepared and attached, the weight of the jib 18 at the time of work can be reduced by performing work with the rope inspection device 7 removed from the jib 18.

In the present embodiment, since the rope deterioration detection instrument 70 can inspect the rope 52 suspended from the point sheave 18S, inspection of the rope 52 can be easily performed even in a configuration where no other idler sheave exists at the tip end of the jib 18. Since it is not necessary to provide a dedicated sheave in order to guide the rope 52 to the rope deterioration detection instrument 70, it is possible to inspect the rope 52 while preventing a significant weight increase of the jib tip end 18Q of the jib 18.

### Second Embodiment

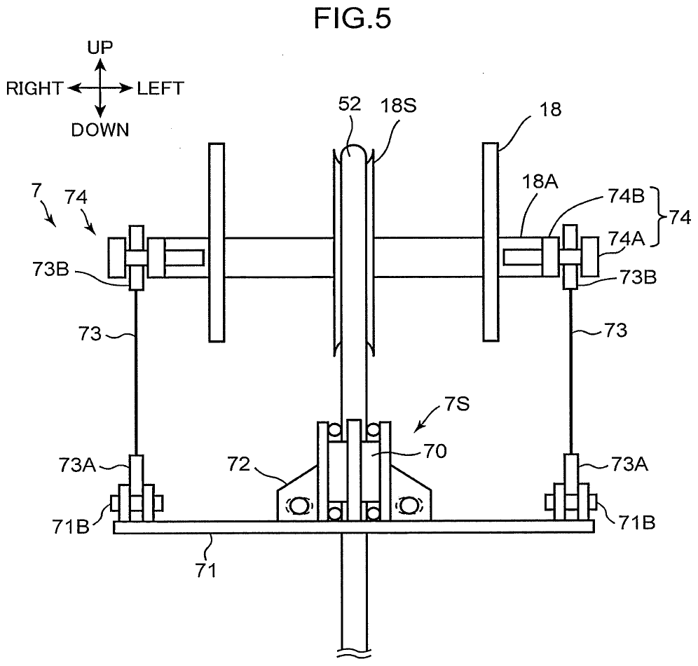

Next, the second embodiment of the present invention will be described. Note that in the present embodiment, differences from the first embodiment described above will be mainly described (the same applies to the embodiments described later). FIG. 5 is a front view of the rope inspection device 7 of the crane 1 according to the present embodiment.

In the present embodiment, the base ends of the pair of left and right support cables 73 of the rope inspection device 7 are supported respectively by both ends of the sheave rotation shaft 18A. Specifically, the both ends of the sheave rotation shaft 18A are disposed so as to protrude outward in the left-right direction relative to each frame of the jib 18. A bolt hole not illustrated is formed in an end surface of the sheave rotation shaft 18A. As a result, as illustrated in FIG. 5, the base end connection part 73B of the support cable 73 and the nut 74B are interposed between the fixing bolt 74A and the end surface of the sheave rotation shaft 18A, and when the fixing bolt 74A is fastened, the support cable 73 is supported by the cable fixing part 74. Note that the base end connection part 73B is supported by the cable fixing part 74 so as to be swingable about the rotation center axis of the sheave rotation shaft 18A.

As described above, in the present embodiment, the sheave rotation shaft 18A can have a function of rotatably supporting the point sheave 18S and a function of supporting the support cable 73. Therefore, the cost and weight of the mechanism attached to the jib tip end 18Q can be reduced as compared with those of the first embodiment described above. Since the fulcrum of the rope 52 and the fulcrum in swinging of the rope deterioration detection instrument 70 can be disposed at close positions, the rope deterioration detection instrument 70 can stably follow movement of the rope 52.

### Third Embodiment

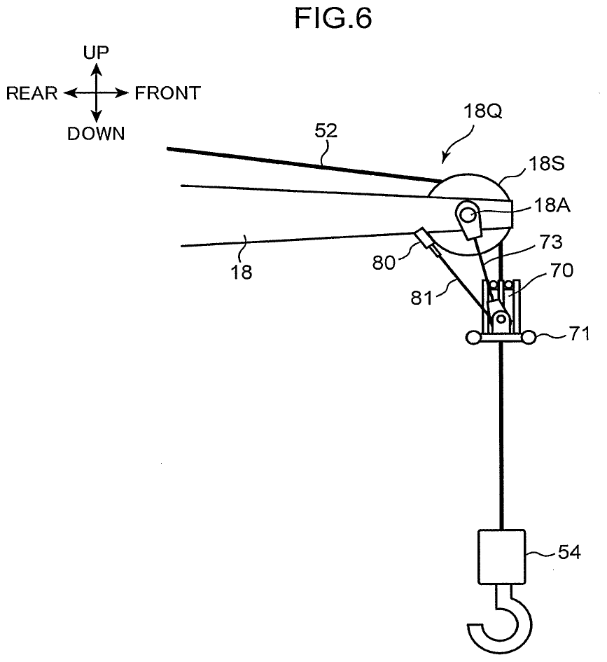

Next, the third embodiment of the present invention will be described. FIGS. 6, 7, and 8 are a side view, a front view, and a perspective view of the rope inspection device 7 of the crane 1 according to the present embodiment.

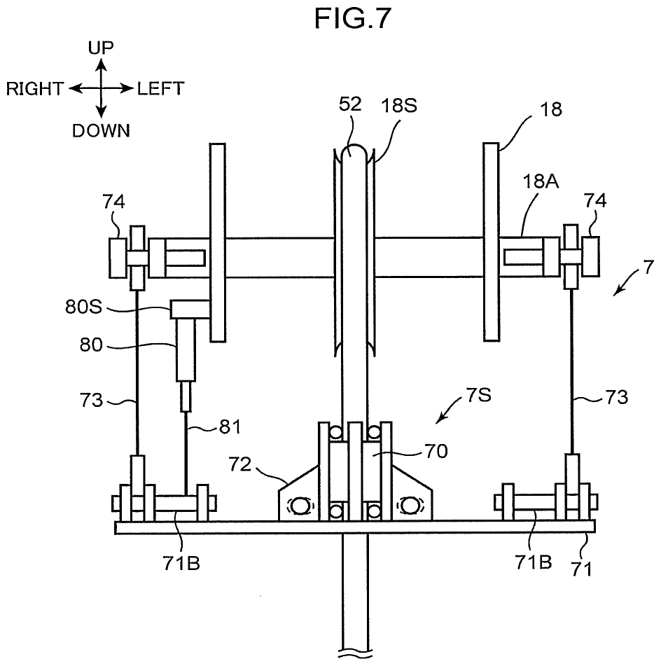

The present embodiment is different from the first embodiment in that the rope inspection device 7 has the function of the cable connection plate 82. Specifically, as illustrated in FIG. 7, the overwound limit switch 80 is supported via a support part 80S by a frame on the right side of the jib 18. The frame supported parts 71B supported by the both ends of the support frame 71 are set so as to extend inward longer than that in the first embodiment. The tip end connection part 73A of the support cable 73 is turnably connected to the pair of left and right frame supported parts 71B, and the tip end of the overwound limit cable 81 is fixed to the frame supported part 71B of the right side.

As described above, in the present embodiment, the support frame 71 (support mechanism) includes the frame supported part 71B (detection cable connection part) connected to the tip end connection part 73A (tip end) of the support cable 73. As a result, the support frame 71 can have a function of supporting the rope deterioration detection instrument 70 and a function as a connection destination of the overwound limit cable 81 of the overwound limit switch 80. As a result, since the cable connection plate 82 in the first embodiment described above can be reduced, the structure of the tip end of the jib 18 can be reduced in weight.

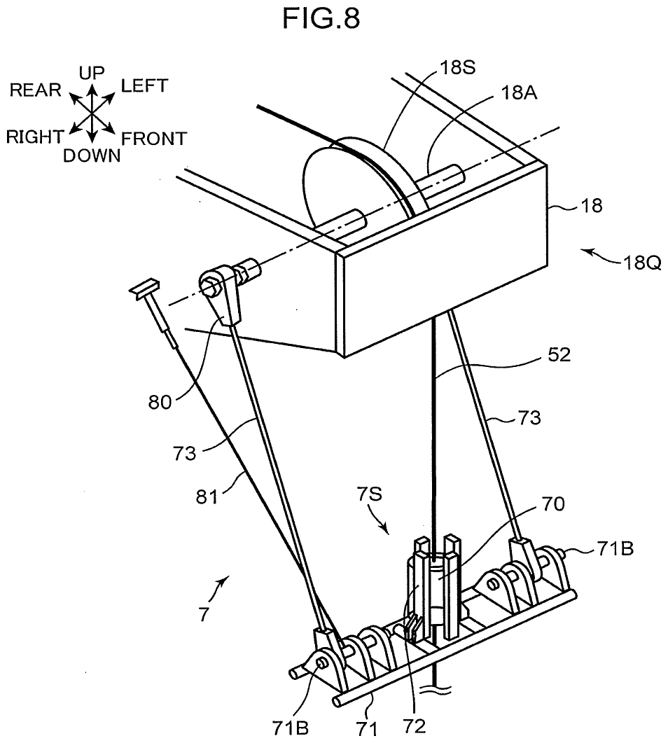

In particular, in the present embodiment, as illustrated in FIGS. 7 and 8, the rope inspection device 7, the overwound limit switch 80, and the overwound limit cable 81 can be accommodated in a space in the up-down direction between the tip end of the jib 18 and the support frame 71. When the rope 52 is overwound, the main hook 53 pushes up the support frame 71, whereby the overwound limit switch 80 can stably detect the overwound state. At this time, since the rope deterioration detection instrument 70 is supported by the support body 72 disposed on an upper surface of the support frame 71, the main hook 53 is prevented from colliding with the rope deterioration detection instrument 70.

### Fourth Embodiment

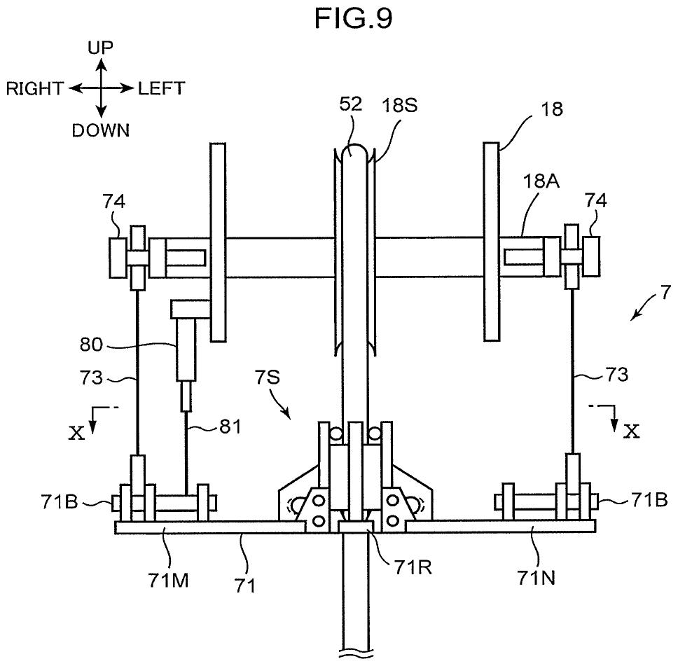

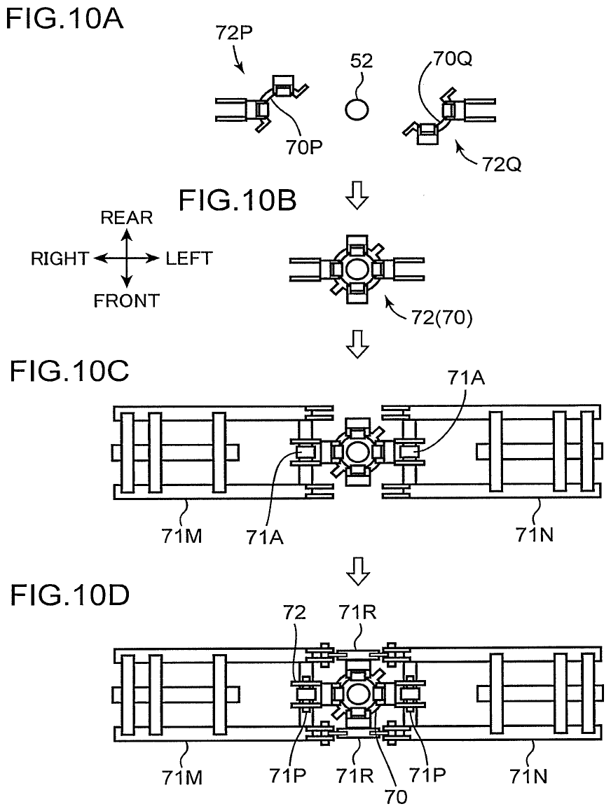

Next, the fourth embodiment of the present invention will be described. FIG. 9 is a front view of the rope inspection device 7 of the crane 1 according to the present embodiment. FIG. 10 is an assembly process diagram of the rope inspection device 7 according to the present embodiment, and corresponds to a view viewed along an arrow X-X of FIG. 9. The present embodiment is characterized in that the support unit 7S of the rope inspection device 7 can be separated left and right. Specifically, as illustrated in FIGS. 9 and 10, the support frame 71 includes left and right first frame part 71M and second frame part 71N, and a pair of front and rear outer connection parts 71R disposed therebetween.

As illustrated in the part (A) of FIG. 10, the support body 72 can be separated into a first support body 72P and a second support body 72Q, and the rope deterioration detection instrument 70 supported by the support body 72 can be separated into a first detection part 70P and a second detection part 70Q. The first detection part 70P is integrated with the first support body 72P, and the second detection part 70Q is integrated with the second support body 72Q.

As illustrated in the part (B) of FIG. 10, the first support body 72P and the second support body 72Q are connected to each other such that the first detection part 70P and the second detection part 70Q sandwich the rope 52. At this time, the first support body 72P and the second support body 72Q are connected by a pin not illustrated. Next, as illustrated in the part (C) of FIG. 10, the first support body 72P and the second support body 72Q are connected by the connection pin 71P to the frame connection parts 71A of the first frame part 71M and the second frame part 71N, respectively. Finally, as illustrated in the part (D) of FIG. 10, the pair of front and rear outer connection parts 71R are connected to the first frame part 71M and the second frame part 71N, respectively, so as to sandwich the support body 72 from front and rear. As a result, the rope deterioration detection instrument 70 can accommodate the rope 52 in a state where the support frame 71 and the support body 72 support the rope deterioration detection instrument 70.

As described above, in the present embodiment, the rope deterioration detection instrument 70 can be separated into two inspection parts, and includes an inspection instrument opening/closing part (the first detection part 70P and the second detection part 70Q) that opens/closes so as to internally receive the rope 52 along the horizontal direction. Therefore, even in a state where the auxiliary hook 54 (FIG. 1) is attached to the tip end of the rope 52, the rope 52 can be easily inserted into the internal space of the rope deterioration detection instrument 70 having a tubular shape. Therefore, the rope inspection device 7 can be easily attached to the jib tip end 18Q of the jib 18.

Furthermore, the support frame 71 and the support body 72 (support mechanism) include a support opening/closing part (the first frame part 71M, the second frame part 71N, the first support body 72P, and the second support body 72Q) that opens/closes so as to receive, along the horizontal direction, the rope deterioration detection instrument 70 accommodating the rope 52. Therefore, it is possible to easily and stably support the rope deterioration detection instrument 70 by opening/closing the support opening/closing part of the support mechanism. As a result, similarly to the above, the rope inspection device 7 can be easily attached to the jib tip end 18Q of the jib 18.

Note that in the present embodiment, an aspect in which the rope deterioration detection instrument 70, the support frame 71, and the support body 72 are each separated into two members, but the present invention is not limited to this. The rope deterioration detection instrument 70, the support frame 71, and the support body 72 may each have a structure that opens/closes such that the rope deterioration detection instrument 70 receives the rope 52 and the support frame 71 and the support body 72 can receive the rope deterioration detection instrument 70. As an example, the first support body 72P and the second support body 72Q may open/close by turning about a turning center axis extending in the up-down direction to internally receive the rope 52. An aspect in which the rope deterioration detection instrument 70, the support frame 71, and the support body 72 are each separated into three or more members can be adopted.

### Fifth Embodiment

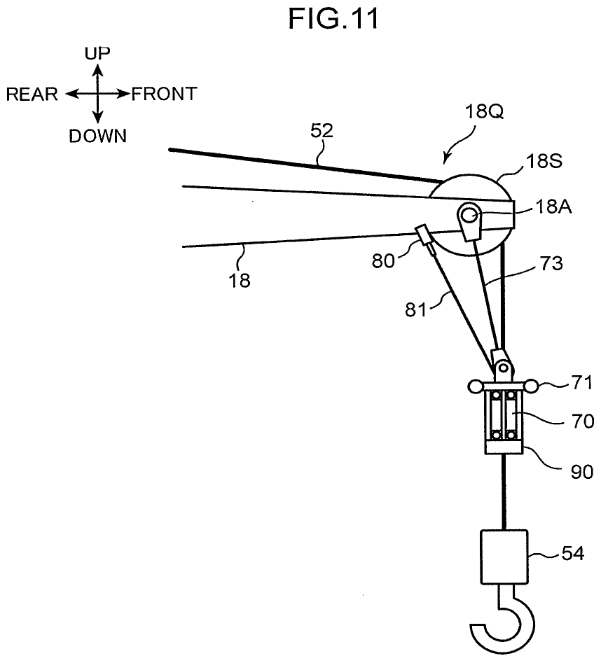

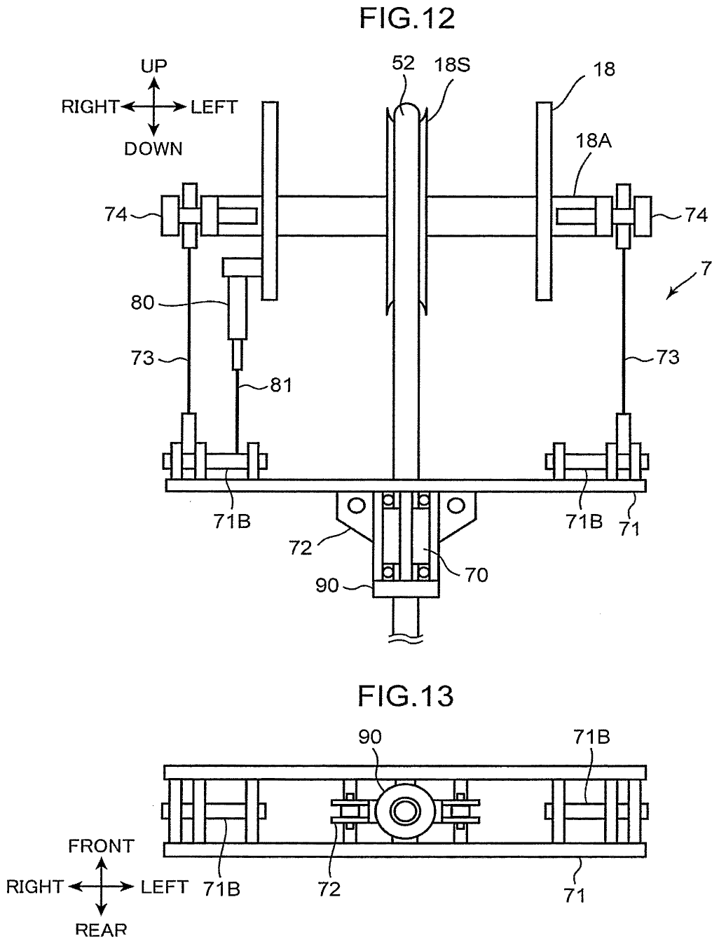

Next, the fifth embodiment of the present invention will be described. FIGS. 11, 12, and 13 are a side view, a front view, and a plan view of a rope inspection device of a crane according to the present embodiment. In the present embodiment, as illustrated in FIG. 12, the support body 72 supports the rope deterioration detection instrument 70 such that the rope deterioration detection instrument 70 is disposed below the support frame 71. Furthermore, the support unit 7S of the rope inspection device 7 further includes a buffer body 90 that is disposed below the rope deterioration detection instrument 70 and mitigates an impact applied to the rope deterioration detection instrument 70. The buffer body 90 is connected to and supported by a lower end of the support body 72. As illustrated in FIG. 13, the buffer body 90 has a cylindrical shape (tubular shape) and is disposed so as to surround (so as to accommodate) the rope 52.

In the present embodiment, since the rope deterioration detection instrument 70 is disposed below the support frame 71, the center of gravity of the rope inspection device 7 is easily stabilized even in a state where the support mechanism (the support frame 71 and the support body 72) is suspended from the jib tip end 18Q of the jib 18, and the behavior of the rope inspection device 7 is suppressed from hindering the work of the crane 1 using the rope 52. Furthermore, since the buffer body 90 is provided below the rope deterioration detection instrument 70, the auxiliary hook 54 and the load to be suspended are prevented from colliding with the rope deterioration detection instrument 70 with a large impact due to overwinding of the rope 52, and damage to the rope deterioration detection instrument 70 is prevented.

In particular, in the present embodiment, since the centers of gravity of the support body 72 and the rope deterioration detection instrument 70 are disposed below the tip end connection part 73A of the support cable 73, the posture of the rope inspection device 7 is easily stabilized, and the rope deterioration detection instrument 70 can stably inspect the rope 52.

Note that also in the present embodiment, similarly to the fourth embodiment described above, the rope deterioration detection instrument 70, the support frame 71, and the support body 72 may have an opening/closing structure, and may internally easily accommodates the rope 52. In this case, the buffer body 90 may similarly include a buffer body opening/closing part that can receive the rope 52 along the horizontal direction. When the buffer body 90 has a cylindrical shape, the buffer body 90 of FIG. 13 may separate (open/close) in a semicircular shape, and may internally receive the rope 52.

According to such a configuration, since the buffer body 90 has a cylindrical shape surrounding the rope 52, it is possible to stably receive an impact from the auxiliary hook 54 or the load to be suspended. Even in a state where the auxiliary hook 54 is attached to the tip end of the rope 52, the rope 52 can be easily inserted into the buffer body 90.

The rope inspection device 7 according to each of the embodiments of the present invention and the crane 1 including the same have been described above. According to the crane 1 including the rope inspection device 7 as described above, even when the rising/lowering body including the jib 18 rises/lowers relative to the upper slewing body 12 or even when the rope 52 swings with the jib tip end 18Q of the jib 18 as a fulcrum, the rope deterioration detection instrument 70 can move following the rope 52, and therefore inspection of the rope 52 can be stably performed. Note that the present invention is not limited to these embodiments. In the present invention, modified embodiments as follows are possible.

(1) The embodiments described above have been described with an aspect in which the rope inspection device 7 is attached to the jib 18, but the rising/lowering body attached with the rope inspection device 7 is not limited to the jib 18, and may be the boom 16. The rope that is an inspection target by the rope inspection device 7 is not limited to the rope 52 of FIG. 1, and may be the rope 51 led out from the main winding winch 34.

(2) The configurations and features of the embodiments described above can be combined with one another.

(3) The embodiments described above has been described using the crane 1 illustrated in FIG. 1, but the present invention is not limited to this, and can be applied also to a crane having another structure. That is, the crane applied with the present invention may be a general-purpose crane including a lattice mast in place of the gantry, and each winch may be disposed on the lattice mast or the boom. The crane applied with the present invention may be a large crane having a structure to raise/lower the boom by raising and lowering of a box mast. Furthermore, the crane applied with the present invention may have a front strut and a rear strut. The travelling structure of the lower travelling body 14 may be a crawler or a tire, or a fixed lower body may be provided in place of the lower travelling body 14. The work machine according to the present invention is not limited to a crane, and may be other aspects.

(4) The embodiment described above has been described with an aspect in which the rope inspection device 7 includes the pair of support cables 73, but the structure for supporting the rope deterioration detection instrument 70 is not limited to the cable structure. As an example, an arc-shaped rail may be disposed at the tip end of the jib 18, and the support frame 71 and the support body 72 (support mechanism) that support the rope deterioration detection instrument 70 may swing along the rail. Also in this case, since the rope deterioration detection instrument 70 can follow movement and swing of the rope 52, the rope 52 can be stably inspected.

Provided by the present invention is a rope inspection device attached to a work machine that has a machine body, a rising/lowering body capable of rising/lowering relative to the machine body, a winch, and a rope which is led out from the winch and suspended from a tip end of the rising/lowering body and which is connected to a load to be suspended. The rope inspection device includes: a rope inspection instrument capable of inspecting a deterioration state of the rope; and a support unit which is attached to the tip end of the rising/lowering body and which supports the rope inspection instrument such that the rope inspection instrument can follow movement in a horizontal direction of the rope which is suspended from the tip end.

According to the present configuration, the support unit supports the rope inspection instrument such that the rope inspection instrument can inspect the rope suspended from the tip end of the rising/lowering body. In particular, the support unit supports the rope inspection instrument such that the rope inspection instrument can follow movement in the horizontal direction of the rope. Therefore, even when the rising/lowering body rises/lowers relative to the machine body or even when the rope swings with the tip end of the rising/lowering body as a fulcrum, the rope inspection instrument can move following the rope, and therefore inspection of the rope can be stably performed.

In the above configuration, the support unit may include a pair of left and right support cables suspended from the tip end of the rising/lowering body, and a support mechanism connected to the tip ends of the pair of support cables and supporting the rope inspection instrument.

According to the present configuration, since the support mechanism supporting the rope inspection instrument is supported by the pair of support cables, the rope inspection instrument can swing with the tip end of the rising/lowering body as a fulcrum so as to follow movement of the rope.

In the above configuration, the rising/lowering body may include a sheave disposed at the tip end and including an outer peripheral surface supporting the rope, and a sheave rotation shaft rotatably supporting the sheave, and the base ends of the pair of left and right support cables may be respectively supported by both ends of the sheave rotation shaft.

According to the present configuration, the sheave rotation shaft can have a function of rotatably supporting the sheave and a function of supporting the support cable. Since the fulcrum of the rope and the fulcrum of the rope inspection instrument can be disposed at close positions, the rope inspection instrument can stably follow movement of the rope.

In the above configuration, the rising/lowering body may include an overwound limit switch attached to the tip end and a detection cable led out from the overwound limit switch, and the support mechanism may further include a detection cable connection part connected to a tip end of the detection cable.

According to the present configuration, the support mechanism can have a function of supporting the rope inspection instrument and a function as a connection destination of the detection cable of the overwound limit switch.

In the above configuration, the support mechanism may include a support frame connected to the tip ends of the pair of support cables, and a support body fixed to a center of the support frame and supporting the rope inspection instrument.

According to the present configuration, the support body can stably support the rope inspection instrument at the center of the support frame in a state where the support frame is supported by the pair of support cables. As a result, the support mechanism is prevented from tilting due to the weight of the rope inspection instrument.

In the above configuration, the rope inspection instrument may have a cylindrical internal space that receives, along an up-down direction, the rope suspended from the tip end of the rising/lowering body.

According to the present configuration, since the rope inspection instrument has a tubular shape involving the rope, the rope inspection instrument and the rope do not greatly separate from each other, and the deterioration state of the rope can be stably inspected.

In the above configuration, the rope inspection instrument may include an inspection instrument opening/closing part that opens/closes so as to receive the rope into the internal space along a horizontal direction.

According to the present configuration, even in a state where the tip end of the rope is attached with the hook, the rope can be easily inserted into the internal space of the tubular rope inspection instrument.

In the above configuration, the support mechanism may further includes a support opening/closing part that supports the rope inspection instrument so as to surround the rope inspection instrument along a horizontal plane, and that opens/closes so as to receive the rope inspection instrument along a horizontal direction.

According to the present configuration, the rope inspection instrument can be easily and stably attached by opening/closing the support opening/closing part of the support mechanism.

In the above configuration, the support body may support the rope inspection instrument such that the rope inspection instrument is disposed below the support frame, and the support unit may further include a buffer body disposed below the rope inspection instrument and mitigating an impact applied to the rope inspection instrument.

According to the present configuration, since the rope inspection instrument is disposed below the support frame, the center of gravity of the rope inspection device is easily stabilized even in a state where the support mechanism is suspended from the tip end of the rising/lowering body, and the behavior of the rope inspection device is suppressed from hindering the work of the work machine using the rope. Furthermore, since the buffer body is provided below the rope inspection instrument, the hook and the load to be suspended are prevented from colliding with the rope inspection instrument with a large impact due to overwinding of the rope, and damage to the rope inspection instrument is prevented.

In the above configuration, the buffer body may have a tubular shape surrounding the rope, and may include a buffer body opening/closing part that can receive the rope along a horizontal direction.

According to the present configuration, since the buffer body has a tubular shape surrounding the rope, it is possible to stably receive an impact from the hook and the load to be suspended. Even in a state where the tip end of the rope is attached with the hook, the rope can be easily inserted into the buffer body.

A work machine according to another aspect of the present invention includes a machine body, a rising/lowering body capable of rising/lowering relative to the machine body, a winch, a rope which is led out from the winch and suspended from a tip end of the rising/lowering body and which is connected to a load to be suspended, and the rope inspection device described in any one of the above attached to the tip end of the rising/lowering body.

According to the present configuration, since the rope inspection instrument can move following the rope even when the rising/lowering body rises/lowers relative to the machine body or even when the rope swings with the tip end of the rising/lowering body as a fulcrum, inspection of the rope can be stably performed.

According to the present invention, it is possible to provide a rope inspection device that can accurately detect deterioration of a suspended load rope used in a work machine, and a work machine including the same.

1. A rope inspection device attached to a work machine that has a machine body, a rising/lowering body capable of rising/lowering relative to the machine body, a winch, and a rope which is led out from the winch and suspended from a tip end of the rising/lowering body and which is connected to a load to be suspended, the rope inspection device comprising:
a rope inspection instrument capable of inspecting a deterioration state of the rope; and
a support unit which is attached to the tip end of the rising/lowering body and which supports the rope inspection instrument such that the rope inspection instrument can follow movement in a horizontal direction of the rope which is suspended from the tip end.

2. The rope inspection device according to claim 1, wherein
the support unit includes
a pair of left and right support cables suspended from the tip end of the rising/lowering body, and
a support mechanism connected to tip ends of the pair of support cables and supporting the rope inspection instrument.

3. The rope inspection device according to claim 2, wherein
the rising/lowering body includes a sheave disposed at the tip end and including an outer peripheral surface supporting the rope, and a sheave rotation shaft rotatably supporting the sheave, and
base ends of the pair of left and right support cables are respectively supported by both ends of the sheave rotation shaft.

4. The rope inspection device according to claim 2, wherein
the rising/lowering body includes an overwound limit switch attached to the tip end and a detection cable led out from the overwound limit switch, and
the support mechanism further includes a detection cable connection part connected to a tip end of the detection cable.

5. The rope inspection device according to claim 2, wherein
the support mechanism includes
a support frame connected to the tip ends of the pair of support cables, and
a support body fixed to a center of the support frame and supporting the rope inspection instrument.

6. The rope inspection device according to claim 5, wherein
the rope inspection instrument has a cylindrical internal space that receives, along an up-down direction, the rope suspended from the tip end of the rising/lowering body.

7. The rope inspection device according to claim 6, wherein
the rope inspection instrument includes an inspection instrument opening/closing part that opens/closes so as to receive the rope into the internal space along a horizontal direction.

8. The rope inspection device according to claim 7, wherein
the support mechanism further includes a support opening/closing part that supports the rope inspection instrument so as to surround the rope inspection instrument along a horizontal plane, and that opens/closes so as to receive the rope inspection instrument along a horizontal direction.

9. The rope inspection device according to claim 6, wherein
the support body supports the rope inspection instrument such that the rope inspection instrument is disposed below the support frame, and
the support unit further includes a buffer body disposed below the rope inspection instrument and mitigating an impact applied to the rope inspection instrument.

10. The rope inspection device according to claim 9, wherein
the buffer body has a tubular shape surrounding the rope, and includes a buffer body opening/closing part that can receive the rope along a horizontal direction.

11. A work machine comprising:
a machine body;
a rising/lowering body capable of rising/lowering relative to the machine body;
a winch;
a rope which is led out from the winch and suspended from a tip end of the rising/lowering body and which is connected to a load to be suspended; and
the rope inspection device according to claim 1 to be attached to the tip end of the rising/lowering body.

12. The rope inspection device according to claim 3, wherein
the rising/lowering body includes an overwound limit switch attached to the tip end and a detection cable led out from the overwound limit switch, and
the support mechanism further includes a detection cable connection part connected to a tip end of the detection cable.

13. The rope inspection device according to claim 3, wherein
the support mechanism includes
a support frame connected to the tip ends of the pair of support cables, and
a support body fixed to a center of the support frame and supporting the rope inspection instrument.

14. The rope inspection device according to claim 4, wherein
the support mechanism includes
a support frame connected to the tip ends of the pair of support cables, and
a support body fixed to a center of the support frame and supporting the rope inspection instrument.

15. The rope inspection device according to claim 7, wherein
the support body supports the rope inspection instrument such that the rope inspection instrument is disposed below the support frame, and
the support unit further includes a buffer body disposed below the rope inspection instrument and mitigating an impact applied to the rope inspection instrument.

16. The rope inspection device according to claim 8, wherein
the support body supports the rope inspection instrument such that the rope inspection instrument is disposed below the support frame, and
the support unit further includes a buffer body disposed below the rope inspection instrument and mitigating an impact applied to the rope inspection instrument.
